(19) United States
(12) Patent Application Publication
(10) Pub. No.: US 2019/0130401 A1
(43) Pub. Date: May 2, 2019

(54) ALTERNATIVE PAYMENT SERVER AND METHOD FOR PROVIDING ALTERNATIVE PAYMENT SERVICE USING SAME

(71) Applicant: Jin KIM, Gyeonggi-do (KR)

(72) Inventor: Jin KIM, Gyeonggi-do (KR)

(21) Appl. No.: 16/200,923

(22) Filed: Nov. 27, 2018

Related U.S. Application Data
(63) Continuation of application No. PCT/KR2017/004828, filed on May 10, 2017.

(30) Foreign Application Priority Data
May 30, 2016 (KR) 10-2016-0066687

(51) Int. Cl. G06Q 20/40; G06Q 20/38

(52) U.S. Cl. CPC G06Q 20/405; G06Q 20/065; G06Q 20/3821

(57) ABSTRACT

An alternative payment server, according to one technical aspect of the present invention, may include: a contract information management unit generating contract information of a contract established between a first party and a second party; and an alternative payment management unit, when receiving a contract term according to the contract information from the first party, freezing deposit and withdrawal of the contract term until the contract according to the contract information is completed, and issuing to the second party a first virtual payment token in which a payment amount corresponding to the contract term is set.

This application relates to International Application No. PCT/KR2017/004828, Filing Date of May 10, 2017, which claims the benefit of Korean Application No. 10-2017-0066687, filed May 30, 2016, each of which is incorporated by reference in their entirety.

### TECHNICAL FIELD

The present invention relates to an alternative payment server and a method of providing an alternative payment service using the same.

### BACKGROUND ART

Due to the development of electronic technology and the Internet, various technologies based on online are applied.

As such a conventional technology, contract management systems that share contract information such as outsourcing are being developed.

A contract price payment is a major issue of a contract, and thus management for the same is required. However, a conventional contract management system provides simple contract information between contractors, that is, provides only data sharing. Accordingly, its effectiveness is limited.

Such a conventional technique may be understood by referencing Korean Patent Application Publication No. 2000-0054430.

### DISCLOSURE

### Technical Problem

Accordingly, the present invention has been made keeping in mind the above problems occurring in the prior art, and an object of the present invention is to provide a an alternative payment server and a method of providing an alternative payment service by using the same wherein precise construction is performed and payment for the same is ensured by securing a payment of a contract price, and providing the contract price after the contract according to contract content is completed.

### Technical Solution

One aspect of the present invention provides an alternative payment system. The alternative payment system may include: a contract information management unit generating contract information of a contract established between a first party and a second party; and an alternative payment management unit, when receiving a contract price according to the contract information from the first party, freezing deposit and withdrawal of the contract price until the contract according to the contract information is completed, and issuing to the second party a first virtual payment token in which a payment amount corresponding to the contract price is set.

In an embodiment, the alternative payment management unit may set a payment term for the first payment token according to the contract, and set the first payment token to be exchanged for cash after the payment term has come.

In an embodiment, when the contract between the second party and a third party is established, the alternative payment management unit may issue to the third party a second payment token corresponding to a partial amount of the first payment token issued to the second party, and set a payment term of the second payment token to be after the payment term of the first payment token.

In an embodiment, the server may further include a beforehand information management unit providing beforehand information of the contract for the first party and the second party before the contract between the first party and the second party has been established.

In an embodiment, the server may further include an in-progress information sharing unit, when receiving in-progress information of the contract from one of the first party and the second party after the contract is established, providing the in-progress information of the contract to the other one of the first party and the second party.

Another aspect of the present invention provides a method of providing an alternative payment service. The method may include: generating contract information of a contract established between a first party and a second party; when receiving a contract price according to the contract information from the first party, freezing deposit and withdrawal of the contract price unit the contract according to the contract information is completed; and issuing to the second party a first virtual payment token in which a payment amount corresponding to the contract price is set.

In an embodiment, the issuing of the first payment token to the second party may include setting a payment term of the first payment token according to the contract, and the first payment token may be set to be exchanged for cash after the payment term has come.

In an embodiment, the method may further include: when a contract between the second party and a third party is established, issuing to the third party a second payment token corresponding to a partial amount of the first payment token issued to the second party.

In an embodiment, a payment term of the second payment token may be set to be after the payment term of the first payment token.

In an embodiment, the method may further include: before the contract between the first party and the second party has been established, providing beforehand information of the contract for the first party and the second party; and when in-progress information of the contract is received from any one of the first party and the second party after the contract is established, providing the contract in-progress information to the other one of the first party and the second party.

The technical solution does not enumerate the features of the present invention. The various technical solutions for the present invention can be understood in more detail with reference to specific embodiments of the following detailed description.

### Advantageous Effects

According to an aspect of the present invention, precise construction can be performed and payment for the same can be ensured by securing a payment of a contract price, and providing the contract price after the contract according to contract content is completed.

In addition, according to another aspect of the present invention, since a payment token is provided on the basis of a cash payment of a contract price, a cash payment can be secured and at the same time, negotiability similar to cash can be provided for a payment token.

### DESCRIPTION OF DRAWINGS

FIG. 1 is a view showing an example of an alternative payment system according to an embodiment of the present invention.

FIG. 2 is a view showing various examples of applying an alternative payment according to an embodiment of the present invention.

FIG. 3 is a view of a block configuration showing an example of an alternative payment server according to an embodiment of the present invention.

FIG. 4 is a view of a block configuration showing an example of an alternative payment management unit shown in FIG. 3.

FIG. 5 is a view of an example of an alternative payment using a payment token according to an embodiment of the present invention.

FIG. 6 is a view of a flowchart showing an example of a method of providing an alternative payment service according to an embodiment of the present invention.

FIG. 7 is a view of a flowchart showing another example of a method of providing an alternative payment service according to an embodiment of the present invention.

### BEST MODE

Hereinafter, preferred embodiments of the present invention will be described with reference to the accompanying drawings.

However, the embodiments of the present invention can be modified into various other forms, and the scope of the present invention is not limited to the following embodiments. In addition, embodiments of the present invention are also provided to more fully describe the present invention to those having average knowledge in the technical field.

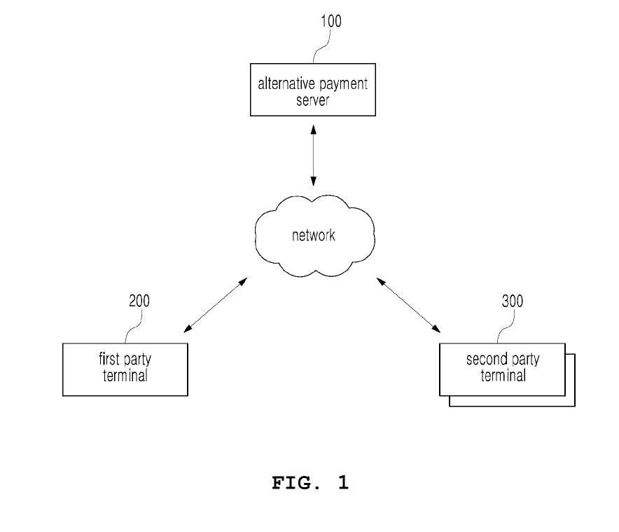

FIG. 1 is a view showing an example of an alternative payment system according to an embodiment of the present invention.

Referring to FIG. 1, an alternative payment system 10 may include an alternative payment server 100, and a first party terminal 200 and a second party terminal 300 connected to the alternative payment server 100.

A first party and a second party are parties to a contract, and may access the alternative payment server 100 by using the first party terminal 200 and the second party terminal 300, respectively. The first party terminal 200 and the second party terminal 300 may correspond to various computing devices, for example, a PC, a tablet, a smartphone, etc.

The alternative payment server 100 may generate contract information between a first party and a second party, and store the same. For example, the alternative payment server 100 may store contract information before the contract is established and provide the same to both parties. In another example, the alternative payment server 100 may store information of a corresponding contract and perform authentication for the same when the contract is established. In another example, the alternative payment server 100 may store contract information from when a contract is established and to when the contract is completed, and provide the same to both parties.

The alternative payment server 100 may receive a payment according to a contract, and issue a payment token according to the same. The alternative payment server 100 may exchange the payment token for cash when it is confirmed that contract content is completed.

A token of the present invention may be issued only by the alternative payment server 100. A party cannot buy the token, and the token may be a means of alternating a payment or cash.

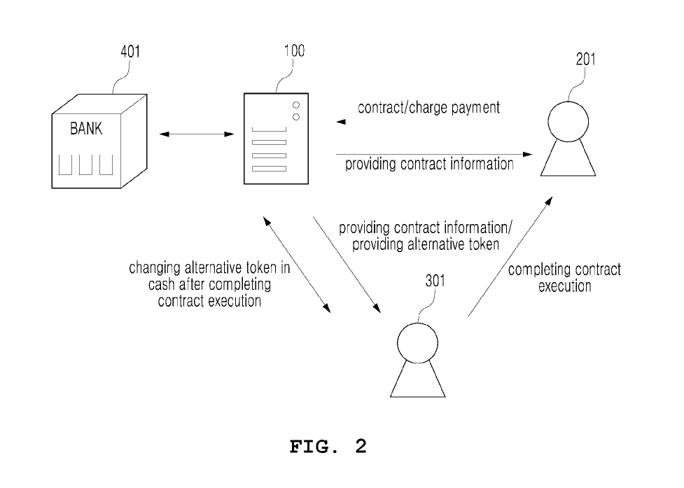

Hereinafter, referring to FIG. 2, an example of providing a payment token will be described in detail.

FIG. 2 is a view showing various examples of applying an alternative payment according to an embodiment of the present invention.

In an example shown in FIG. 2, a first party 201 is entitled to enjoy the rights of the party A. For example, the first party 201 may be a contractor or buyer that is a party that receives an article or service by paying for the same.

A second party 301 is a party who is entitled to enjoy the rights of the party B. For example, the second party 301 may be a contractee or seller that provides an article or service by receiving a payment for the same.

The alternative payment server 100 may generate a contract according to information input by the first party 201 and the second party 301, and provide the generated contract information to the first party 201 and the second party 301.

When confirmation for the generated contract information is made by the first party 201 and the second party 301, it may be regarded that the corresponding contract has been established.

The alternative payment server 100 may receive a contract price of a corresponding contract from the first party 201, and store the same in a specific account 401. The alternative payment server 100 may generate an alternative token corresponding to the contract price, and issue the same to the second party 301.

An alternative token may be a virtual currency valid between contract parties. When a contract is executed by the action of the second party 301, the second party 301 may return an alternative token to the alternative payment server 100 and receive a payment corresponding to the same.

FIG. 2 is a view showing an example of an alternative payment according to a contract relation, and the alternative payment server may provide various services in addition to the same.

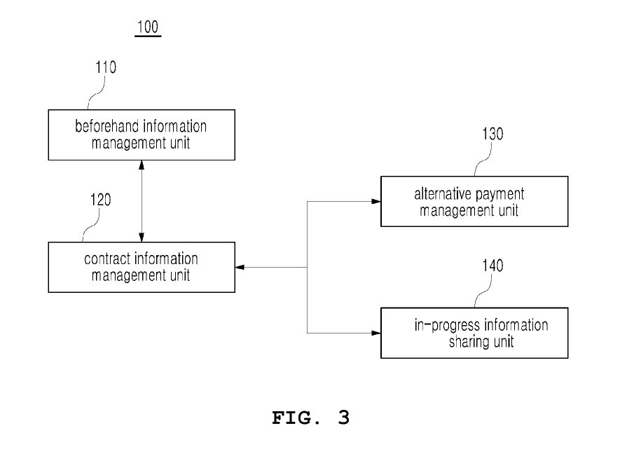

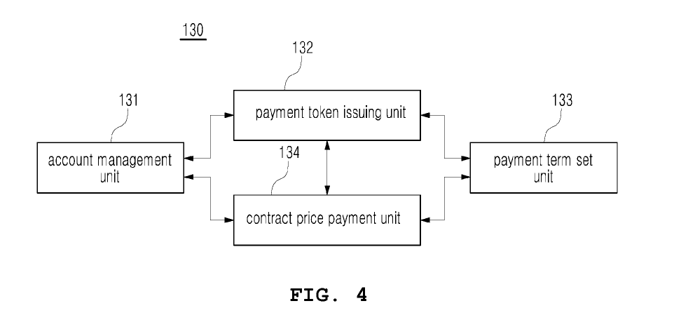

Hereinafter, referring to FIGS. 3 and 4, various examples of the alternative payment server according to an embodiment of the present invention will be described.

FIG. 3 is a view of a block configuration showing an example of an alternative payment server according to an embodiment of the present invention.

Referring to FIG. 3, the alternative payment server 100 may include a contract information management unit 120 and an alternative payment management unit 130. According to an embodiment, the alternative payment server 100 may further include a beforehand information management unit 110 or an in-progress information sharing unit 140.

The contract information management unit 120 may generate contract information of a contract established between a first party and a second party.

For example, the contract information management unit 120 may generate contract information according to information input by a first party or a second party, and performs content confirmation of the generated contract information by providing the same to the first party 201 and the second party 301. The contract information management unit 120 may regard that the corresponding contract has been established when the first party and the second party confirm the contract information.

When a contract has been established, the alternative payment management unit 130 may receive a corresponding contract price from one party, and issue to the other party a payment token corresponding to the contract price.

For example, when the alternative payment management unit 130 receives a contract price according to contract information from a first party, the alternative payment management unit 130 may issue to a second party a first virtual payment token in which a payment amount corresponding to the contract price is set. Herein, the alternative payment management unit 130 may set to freeze the deposit and withdrawal of the contract price until the contract according to contract information is completed. Accordingly, the payment amount may be prevented from being used and the payment may be secured since the payment amount is frozen during a corresponding period.

The alternative payment management unit 130 may set a payment term for a first payment token according to a contract. Herein, the first payment token may be set to be exchanged for cash after the payment term has come.

The alternative payment management unit 130 may issue a payment token that is issued to a second party to another party, for example, a third party corresponding a subcontractor of the second party. For example, when a contract is established between a second party and a third party, the alternative payment management unit 130 may issue to the third party a second payment token corresponding to a partial amount of a first payment token issued to the second party.

Herein, a payment token re-issued to the sub-contractor may have a stipulated term grater than a stipulated term grater of an original payment token. For example, a payment term of a second payment token may be set to be after a payment term of a first payment token.

The beforehand information management unit 110 may provide, to a first party and a second party, contract beforehand information before the contract between the first party and the second party is established. For example, the beforehand information management unit 110 may store and provide to both parties information of contract construction preparation, construction related data, estimation, and verification when the same is received from one party.

In an embodiment, the beforehand information management unit 110 may provide at least a partial piece of beforehand information to the contract information management unit 120, and the contract information management unit 120 may automatically generate contract information by reflecting the beforehand information received from the beforehand information management unit 110. For example, the beforehand information management unit 110 may provide construction estimation data to the beforehand information management unit 110, and the beforehand information management unit 110 may generate contract information by reflecting the above construction estimation data in a contract.

In an embodiment, when changes occur in beforehand information, the beforehand information management unit 110 may provide the same to the contract information management unit 120. The contract information management unit 120 may automatically change contract information by reflecting changes in the provided beforehand information. Accordingly, when information changes in a contract preparation step, the same may be automatically reflected in a contract.

The in-progress information sharing unit 140 may provide information after the contract has been established. In other words, when the in-progress information sharing unit 140 receives information of a contract progress situation from any one of a first party and a second party after the contract has been established, the in-progress information sharing unit 140 may provide information of the contract progress situation to the other one of the first party and the second party.

For example, the in-progress information sharing unit 140 may provide construction site information, troubleshooting information, etc. In addition, the in-progress information sharing unit 140 may provide a communication service between a contract party and a constriction manager.

FIG. 4 is a view of a block configuration showing an example of an alternative payment management unit shown in FIG. 3.

Referring to FIG. 4, the alternative payment management unit 130 may include an account management unit 131, a payment token issuing unit 132, a payment term set unit 133, and a contract price payment unit 134.

The account management unit 131 may manage an account through which deposit and withdrawal of a contract price is managed.

When a contract is established and a contract price is input, the account management unit 131 may inform the payment token issuing unit 132 about the same.

The account management unit 131 may set to freeze deposit and withdrawal of a contract term until execution of the contract is completed. When contract execution is reported from a second party and a first party confirms for the same, the account management unit 131 may release the deposit and withdrawal of the contract price that is in a frozen state. According to an embodiment, the account management unit 131 may release deposit and withdrawal of a contract price that is in a frozen state after a payment term has come.

When an input of a contract price from the account management unit 131 is confirmed, the payment token issuing unit 132 may issue to a second party a payment token corresponding to the contract term. In addition, the payment token issuing unit 132 may divide the payment token that has been already issued, and issue to a third party as described above.

In an embodiment, the payment token issuing unit 132 may reflect a payment term provided from the payment term set unit 133, and set the payment term for the payment token to be issued.

The payment term set unit 133 may set a payment term for a payment token according to content of a contract.

The payment term set unit 133 may provide a payment term to the payment token issuing unit 132, so that information of the payment term for the payment token may be associated when issuing the payment token.

Alternatively, the payment term set unit 133 may provide a payment term to the contract term payment unit 134 so as to confirm whether or not the payment term is satisfied when the payment token is returned and exchanged for cash.

The contract term payment unit 134 may get back a payment token from a second party or a third party, and provide a contract term to the second party or the third party by associating with the account management unit 131.

When getting back a payment token, the contract term payment unit 134 may provide a contract term corresponding to the payment token when a payment term for the payment token has come. Accordingly, for a payment token that a payment term for the same has not come, exchanging in cash is not possible.

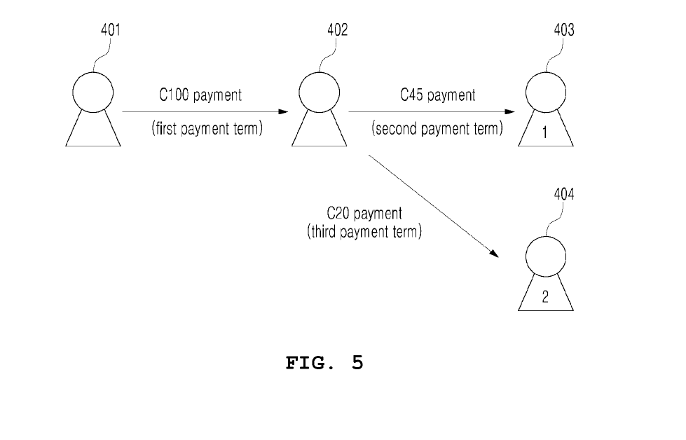

FIG. 5 is a view of an example of an alternative payment using a payment token according to an embodiment of the present invention.

In an example shown in FIG. 5, an example is shown where a first party 401 and a second party 402 establish a contract corresponding to a first payment token C100, and the first payment token C100 is paid to the second party 402 according to the same.

The second party 402 establishes a contract with a third party 403 and a fourth party 404 that are subcontractors, and a second payment token C45 and a third payment token C20 may be paid respectively according to the same.

As described above, a payment token may perform a currency function between contract parties in the present alternative payment system.

Meanwhile, each of payment tokens may have a different payment term. In an example shown in the figure, a first payment token may have a first payment term, a second payment token may have a second payment term, and a third payment token may have a third payment term.

Herein, a lower level payment token may be paid after a payment term of an upper level payment token has come. In other words, the second payment term and the third payment term are set to be after the first payment term. This is because exchanging for cash of the first payment token is secured after the first payment term has come, so that a payment term of a derivative payment token (second and third payment tokens) of the payment token is set to be after the first payment term. Meanwhile, the second payment term and the third payment term may be independently set from each other.

In the above, an alternative payment system and an alternative payment server according to the present invention have been described with reference to FIGS. 1 to 5.

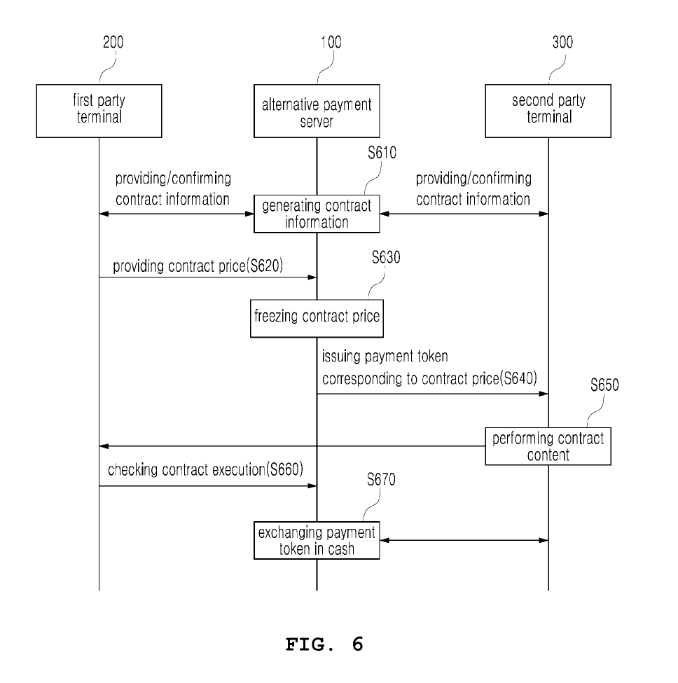

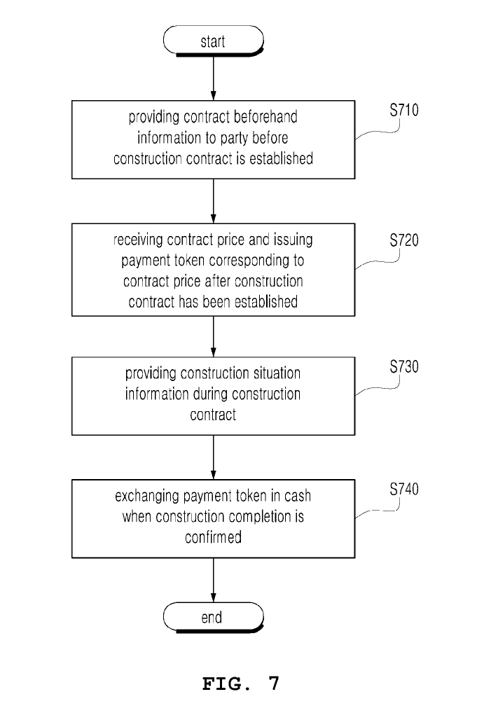

Hereinafter, referring to FIGS. 6 and 7, a method of providing an alternative payment service according to an embodiment of the present invention will be described. However, a method of providing an alternative payment service which will be described below is performed in the alternative payment server according to the present invention, and thus the method will be easily understood by referencing description described with FIGS. 1 to 5.

FIG. 6 is a view of a flowchart showing an example of a method of providing an alternative payment service according to an embodiment of the present invention.

Referring to FIG. 6, in S610, the alternative payment server 100 may generate contract information of a contract established between a first party and a second party by associating with a first party terminal 200 and a second party terminal 30.

When the alternative payment server 100 receives a contract term according to the contract information from the first party terminal 200 in S620, in S630, the alternative payment server 100 may freeze deposit and withdrawal of the contract term until the contract according to the contract information is completed.

Subsequently, in S640, the alternative payment server 100 may issue to the second party a virtual payment token in which a payment amount corresponding to the contract term is set.

In an embodiment for S640, the alternative payment server 100 may set a payment term for a first payment token according to the contract. Herein, the first payment token may be set to be exchanged for cash after the payment term has come.

In S650, when contract content is executed by the second party 300, the same is inform to the first party 200, and in S660, the first party 200 may confirm the alternative payment server 100 that the contract execution has been completed.

As described above, when it is confirmed that the contract execution has been completed, in S670, the alternative payment server 100 may exchange for cash the payment token as a contract term.

In an embodiment, the alternative payment server 100 may issue to a third party a second payment token corresponding to a part of the first payment token that is issued to the second party when a contract between the second party and the third party is established. Herein, a payment term of the second payment token may be set to be after the payment term of the first payment token.

FIG. 7 is a view of a flowchart showing another example of a method of providing an alternative payment service according to an embodiment of the present invention. In an example shown in FIG. 7, an example is shown where the method is applied to a contract of a subcontractor. However, the example is an illustrative example, it is obvious that the present invention is applicable to article purchase transactions and other service transactions in addition to subcontractor transactions.

In S710, the alternative payment server 100 may provide to the first party and the second party beforehand information of a construction contract which is information before the construction contract between the first party and the second party has been established.

When a contract is established, in S720, the alternative payment server 100 may receive a contract term form the first party, and provide to the second party a payment token corresponding to the contract term. S720 will be easily understood by referencing description of described with FIG. 6.

After the contract is established, in S730, when the alternative payment server 100 receives information of a contract progress situation from any one of the first party and the second party, the alternative payment server 100 may provide the information of the contract progress situation to the other one of the first party and the second party.

In S740, when a construction according to the contract is successfully completed, the alternative payment server 100 may exchange in cash the payment token paid to the second party.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An alternative payment server, the server comprising:
a contract information management unit generating contract information of a contract established between a first party and a second party; and
an alternative payment management unit, when receiving a contract price according to the contract information from the first party, freezing deposit and withdrawal of the contract price until the contract according to the contract information is completed, and issuing to the second party a first virtual payment token in which a payment amount corresponding to the contract price is set.

2. The server of claim 1, wherein the alternative payment management unit sets a payment term for the first payment token according to the contract, and sets the first payment token to be exchanged for cash after the payment term has come.

3. The server of claim 2, wherein when a contract between the second party and a third party is established, the alternative payment management unit issues to the third party a second payment token corresponding to a partial amount of the first payment token issued to the second party, and sets a payment term of the second payment token to be after the payment term of the first payment token.

4. The server of claim 1, further comprising a beforehand information management unit providing beforehand information of the contract for the first party and the second party before the contract between the first party and the second party has been established.

5. The server of claim 4, further comprising an in-progress information sharing unit, when receiving in-progress information of the contract from one of the first party and the second party after the contract is established, providing the in-progress information of the contract to the other one of the first party and the second party.

6. A method of providing an alternative payment service, the method comprising:
generating contract information of a contract established between a first party and a second party;
when receiving a contract price according to the contract information from the first party, freezing deposit and withdrawal of the contract price unit the contract according to the contract information is completed; and
issuing to the second party a first virtual payment token in which a payment amount corresponding to the contract price is set.

7. The method of claim 6, wherein the issuing of the first payment token to the second party includes setting a payment term of the first payment token according to the contract, wherein the first payment token is set to be exchanged for cash after the payment term has come.

8. The method of claim 6, further comprising: when a contract between the second party and a third party is established, issuing to the third party a second payment token corresponding to a partial amount of the first payment token issued to the second party.

9. The method of claim 8, wherein a payment term of the second payment token is set to be after the payment term of the first payment token.

10. The method of claim 6, further comprising:
before the contract between the first party and the second party has been established, providing beforehand information of the contract for the first party and the second party; and
when in-progress information of the contract is received from any one of the first party and the second party after the contract is established, providing the contract in-progress information to the other one of the first party and the second party.
